(19) United States
(12) Patent Application Publication
(10) Pub. No.: US 2010/0146565 A1
(43) Pub. Date: Jun. 10, 2010

(54) System and Method for Verifying Deployment of an Internet Protocol Television Video on Demand Asset

(75) Inventors: Kenneth Ospalik, Plainfield, IL (US); John Mathew, Mount Prospect, IL (US); Marisa Earnshaw, Naugatuck, CT (US); Giya Tektumanidze, Riverwood, IL (US)

Correspondence Address: AT&T Legal Department - LNA;Attn: Patent Docketing, Room 2A- 207, One AT & T Way, Bedminster, NJ, 07921, US

(73) Assignee: AT&T CORP., New York, NY (US)

(21) Appl. No.: 12/331,095

(22) Filed: Dec. 9, 2008

(51) Int. Cl. H04N 7/173

(52) U.S. Cl. 725/87

(57) ABSTRACT

A system includes a subscriber event transmission interface and an enterprise data warehouse. The subscriber event transmission interface is configured to collect first video-on-demand asset metadata from a first video head-end office. The enterprise data warehouse is in communication with the subscriber event transmission interface. The enterprise data warehouse is configured to store a list of a video-on-demand assets deployed to the video head-end office based on the first video-on-demand asset metadata.

### FIELD OF THE DISCLOSURE

The present disclosure generally relates to communications networks, and more particularly relates to a system and method for verifying deployment of an Internet Protocol television video on-demand asset.

### BACKGROUND

In an Internet Protocol television system, video head-end offices (VHOs) are placed in different geographical regions to provide television content and video-on-demand content to users in each specific region. Multiple VHOs can receive television content and video-on-demand content from a single super head-end office (SHO). The SHO can send each of the VHOs the same television content and video-on-demand content, different television content and video-on-demand content, and/or any combination of similar and different television content and video-on-demand content. The television content and video-on-demand content for each VHO can be based on the geographical region covered by the VHO.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an Internet Protocol Television (IPTV) system;

FIG. 2 is a block diagram illustrating an embodiment of an IPTV network;

FIG. 3 is a block diagram of a video head-end office of the IPTV network;

FIG. 4 is a flow diagram of a method for verifying a video-on-demand asset deployment to a video head-end office;

FIG. 5 is a flow diagram of an alternative method for verifying a video-on-demand asset deployment to a video head-end office; and

FIG. 6 is a block diagram of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

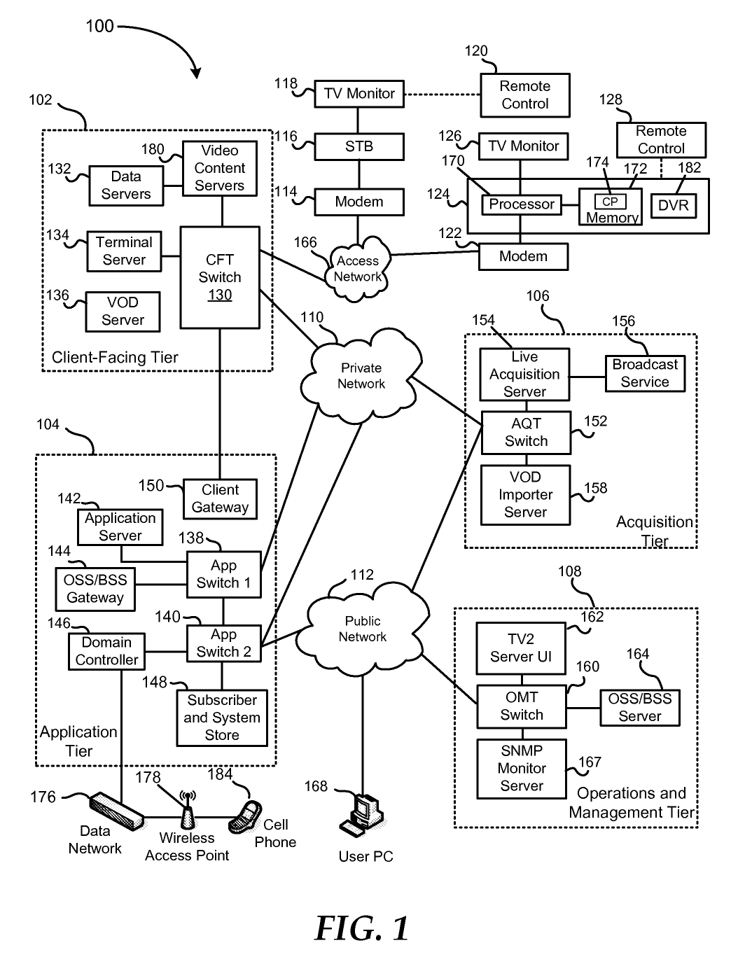

FIG. 1 shows an IPTV system 100 including a client facing tier 102, an application tier 104, an acquisition tier 106, and an operations and management tier 108. Each tier 102, 104, 106, and 108 is coupled to one or both of a private network 110 and a public network 112. For example, the client-facing tier 102 can be coupled to the private network 110, while the application tier 104 can be coupled to the private network 110 and to the public network 112 such as the Internet. The acquisition tier 106 can also be coupled to the private network 110 and to the public network 112. Moreover, the operations and management tier 108 can be coupled to the public network 112.

The various tiers 102, 104, 106 and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166. In an illustrative embodiment, modems such as a first modem 114 and a second modem 122 can be coupled to the private access network 166. The client-facing tier 102 can communicate with a first representative set-top box device 116 via the first modem 114 and with a second representative set-top box device 124 via the second modem 122. The client-facing tier 102 can communicate with a large number of set-top boxes over a wide geographic area, such as a regional area, a metropolitan area, a viewing area, or any other suitable geographic area that can be supported by networking the client-facing tier 102 to numerous set-top box devices. In one embodiment, the client-facing tier 102 can be coupled to the modems 114 and 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116 and 124 can process data received from the private access network 166 via an IPTV software platform such as Microsoft® TV IPTV Edition.

The first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device can communicate with a second remote control 128. In an exemplary, non-limiting embodiment, each set-top box device 116 and 124 can receive data or video from the client-facing tier 102 via the private access network 166 and render or display the data or video at the display device 118 or 126 to which it is coupled. The set-top box devices 116 and 124 thus may include tuners that receive and decode television programming information for transmission to the display devices 118 and 126. Further, the set-top box devices 116 and 124 can include a set-top box processor 170 and a set-top box memory device 172 that is accessible to the set-top box processor. In a particular embodiment, the set-top box devices 116 and 124 can also communicate commands received from the remote controls 120 and 128 back to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides terminal devices, such as a game application server and other devices with a common connection point to the private network 110. In a particular embodiment, the CFT switch 130 can also be coupled to a video-on-demand (VOD) server 136.

The application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116 and 124 via the private access network 166, so the set-top box devices 116 and 124 can provide functions such as display, messaging, processing of IPTV data and VOD material. In a particular embodiment, the OSS/BSS gateway 144 includes operation systems and support (OSS) data, as well as billing systems and support (BSS) data.

The second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116 and 124 can access the system via the private access network 166 using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices, from accessing the private network 110 by denying access to these devices beyond the private access network 166.

For example, when the set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the set-top box device 116 access to IPTV content and VOD content. If the client gateway 150 cannot verify subscriber information for the set-top box device 116, such as because it is connected to a different twisted pair, the client gateway 150 can deny transmissions to and from the set-top box device 116 beyond the private access network 166.

The acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch can be coupled to a video-on-demand importer server 158 that stores television content received at the acquisition tier 106 and communicate the stored content to the client-facing tier 102 via the private network 110.

The operations and management tier 108 can include an operations and management tier (OMT) switch 160 that conducts communication between the operations and management tier 108 and the public network 112. In the illustrated embodiment, the OMT switch 160 is coupled to a TV2 server 162. Additionally, the OMT switch 160 can be coupled to an OSS/BSS server 164 and to a simple network management protocol (SNMP) monitor 167 that monitors network devices. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 in turn can transmit the television content to the AQT switch 152 and the AQT switch can transmit the television content to the CFT switch 130 via the private network 110. Further, the television content can be encoded at the D-servers 132, and the CFT switch 130 can communicate the television content to the modems 114 and 122 via the private access network 166. The set-top box devices 116 and 124 can receive the television content from the modems 114 and 122, decode the television content, and transmit the content to the display devices 118 and 126 according to commands from the remote control devices 120 and 128.

Additionally, at the acquisition tier 106, the VOD importer server 158 can receive content from one or more VOD sources outside the IPTV system 100, such as movie studios and programmers of non-live content. The VOD importer server 158 can transmit the VOD content to the AQT switch 152, and the AQT switch 152 in turn can communicate the material to the CFT switch 130 via the private network 110. The VOD content can be stored at one or more servers, such as the VOD server 136.

When a user issues a request for VOD content to the set-top box device 116 or 124, the request can be transmitted over the private access network 166 to the VOD server 136 via the CFT switch 130. Upon receiving such a request, the VOD server 136 can retrieve requested VOD content and transmit the content to the set-top box device 116 or 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer (PC) 168 coupled to the public network 112.

The domain controller 146 communicates with the public network 112 via the second APP switch 140. Additionally, the domain controller 146 can communicate via the public network 112 with the PC 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access device 178 can communicate with user wireless devices such as a cellular telephone 184.

In a particular embodiment, the set-top box devices can include a set-top box computer program 174 that is embedded within the set-top box memory device 172. The set-top box computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124 by associating the user account with an IP address of the second set-top box device, with data relating to one or more twisted pairs connected with the second set-top box device, with data related to one or more fiber optic cables connected with the second set-top box device, with an alphanumeric identifier of the second set-top box device, with any other data that is suitable for associating the second set-top box device with a user account, or with any combination of these.

The set-top box computer program 174 can contain instructions to receive many types of user preferences from the domain controller 146 via the access network 166. For example, the set-top box computer program 174 can include instructions to receive a request to record at least one television program at a video content storage module such as a digital video recorder (DVR) 182 within the second set-top box device 124. In this example embodiment, the set-top box computer program 174 can include instructions to transmit the request to the DVR 182, where the television program(s) are recorded. In an illustrative embodiment, the set-top box computer program 174 can include instructions to receive from the DVR 182 a recording status with respect to one or more of the television programs and to transmit at least one message regarding the status to a wireless device, such as the cellular telephone 184. The message can be received at the CFT switch 130, for instance, and communicated to the domain controller 146 across the private network 110 via the second APP switch 140. Further, the domain controller 146 can transmit the message to the wireless data network 176, directly or via the public network 112, and on to the wireless network access point 178. The message can then be transmitted to the cellular telephone 184. In an illustrative embodiment, the status can be sent via a wireless access protocol (WAP).

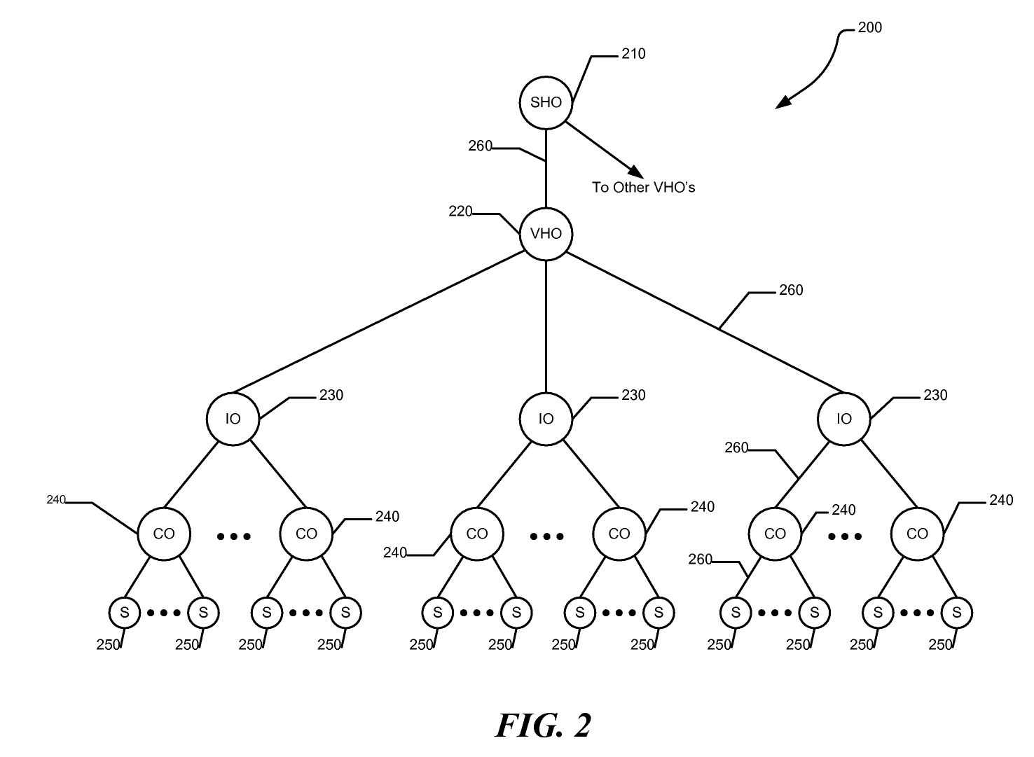

FIG. 2 shows one example embodiment of a television distribution system or network 200, using IPTV technology in this example but not limited thereto, adapted to provide, among other things, the VOD content. The network 200 may include a super head-end office (SHO) 210 for acquisition and encoding of video content, one or more video head-end offices (VHO) 220 in each demographic market area (DMA), one or more intermediate offices (IO) 230, one or more central offices (CO) 240 located in each metropolitan area, and subscribers 250, who may be located in single or multiple dwelling units. In one example embodiment, the network 200 may be connected through a plurality of high speed communication links 260 using physical transport layers such as fiber, cable, twisted pair, air, or other media.

In one example embodiment of the IPTV video delivery system, the SHO 210 distributes VOD content to one or more VHOs 220, which may be spread across a wide geographic territory, such as an entire country. The SHO 210 may, for example, be in a central location for acquisition and aggregation of national-level broadcast television (or linear) programming, and VOD assets. A redundant SHO 210 may be provided for backup in case of failure. The SHO 210 may also provide the central point of VOD content acquisition and insertion into the IPTV network. VOD content may be received from various sources and processed/encoded to codec and bit-rate requirements for the communication network for transmission to the VHO 220 over the high speed communication links. The VHOs 220 are the video distribution points within each DMA or geographic region.

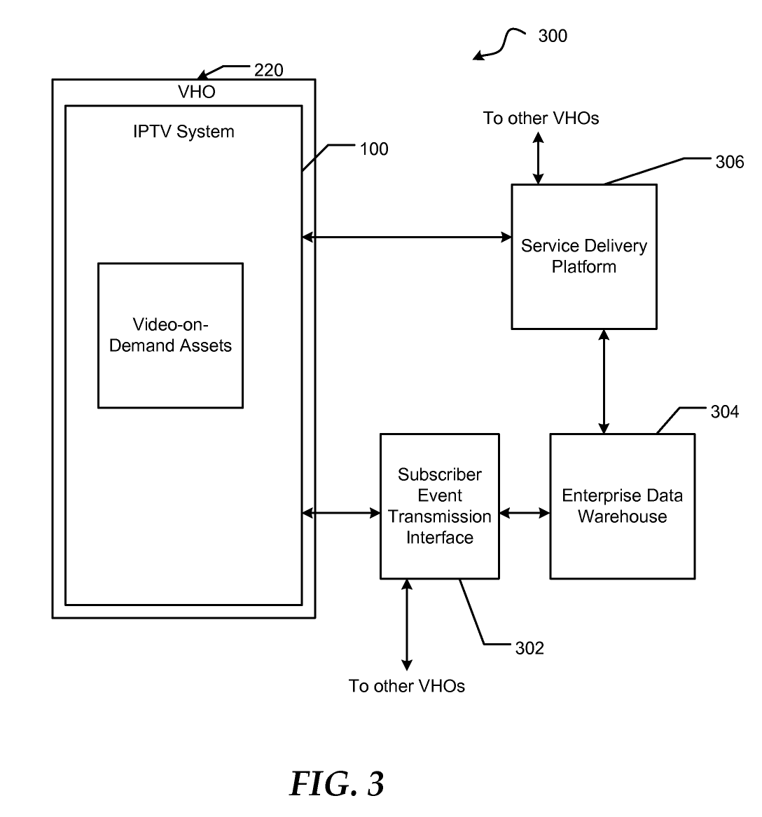

FIG. 3 shows a backend 300 of the IPTV network 200. The backend 300 includes a subscriber event transmission interface (SETI) module 302, an enterprise data warehouse (EDW) 304, and a service delivery platform (SDP) 306. The SETI module 302 is in communication with the IPTV system 100 and with the EDW 304. The EDW 304 is in communication with the SDP 306, which in turn is in communication with the IPTV system 100 of the VHO 220. The SHO 210, shown in FIG. 2, can send VOD assets to the different VHOs 220. The VOD assets sent to the VHOs 220 can vary based on the geographic location of the VHOs.

Upon the VOD assets being deployed to the VHOs 220, the SETI 302 can connect to a server within the IPTV system, such as the VOD server 136 of FIG. 1, of each of the VHOs, and can retrieve metadata associated with each of the VOD assets deployed to each of the VHOs. The metadata can include different information about the VOD asset, such as title, summary, rating, run time, year, actors, writers, director, producers, studio, category, genre, licensing start date, licensing end date, suggested price, and the like. Upon the VOD asset metadata being pulled from the VHO 220, the SETI 302 can build a file containing the distinct metadata elements that document the details of the VOD asset. This file can then be sent to the EDW 304 via a secure network of the service provider transmitting the VOD assets to the VHO 220. The SETI 302 can also be connected to other VHOs 220 and perform the same process for the VOD assets provided to these VHOs. Additionally, the SETI 302 can periodically retrieve the metadata from the VHOs 220, and each time the SETI can retrieve the metadata for the VOD assets that were deployed to the VHOs 220 since a last metadata retrieval performed by the SETI.

After receipt, the EDW 304 can send the metadata file to the SDP 306 for validation of the VOD assets. The SDP 306 can compare the metadata file with metadata stored in the SDP for the VOD assets deployed to the different VHOs 220 to verify which of the VOD assets were sent from the SHO 210 to each of the VHOs. Because the VHOs 220 deploy the VOD assets to different geographic areas, the metadata file is preferably created by the SETI 302 for each of the VOD assets in a particular VHO. Upon the SPD 306 verifying that a specific VOD asset has been deployed to a specific VHO 220, the metadata file for the VOD asset can be used by the service provider for various operations, such as to market the VOD assets in the geographic region covered by the VHO. For example, the service provider can use the metadata for the VOD asset to advertise the VOD asset based on the price, the genre, the actors, and the like of the VOD asset. Thus, the VOD assets deployed to each VHO 220 can be verified by the SETI 302, the EDW 304, and the SDP 306. Upon verification of the VOD assets deployed to a VHO 220, the service provider can use the metadata file for the VOD assets to provide a better experience for the users of the IPTV system 100.

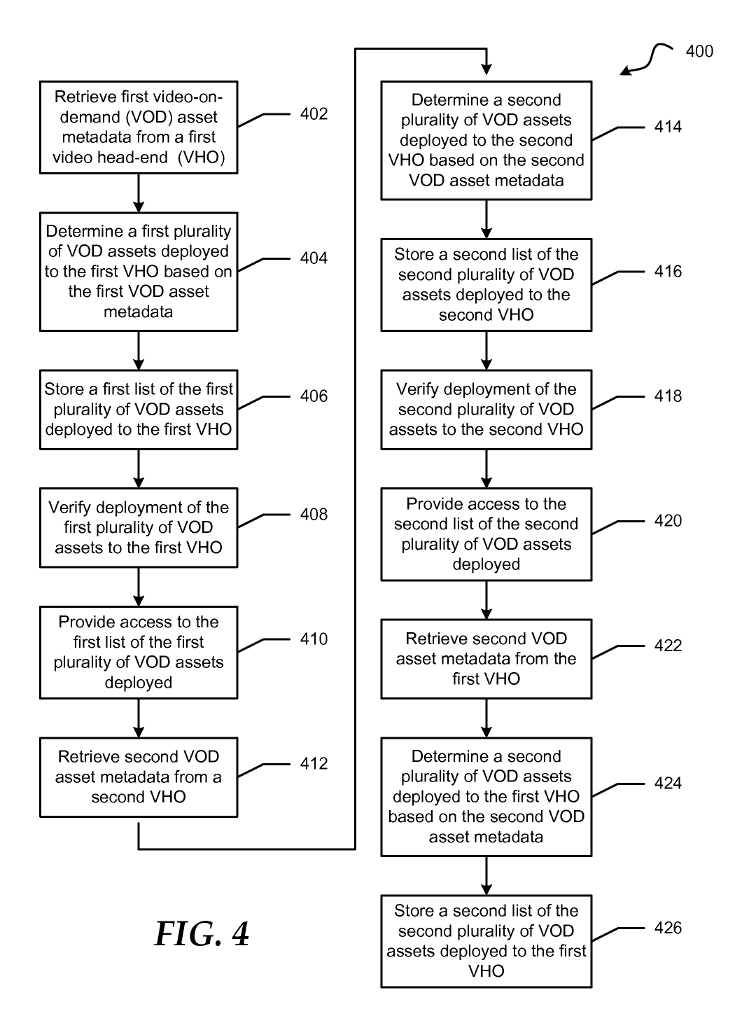

FIG. 4 shows a method 400 for verifying deployment of a VOD asset to a VHO. At block 402, first VOD asset metadata is retrieved from a first VHO. A first plurality of VOD assets deployed to the first VHO is determined based on the first VOD asset metadata at block 404. At block 406, a first list of the first plurality of VOD assets deployed to the first VHO is stored. Deployment of the first plurality of VOD assets to the first VHO is verified at block 408. At block 410, access to the first list of the first plurality of VOD assets deployed is provided. The access to the first list of the first plurality of VOD assets deployed can preferably be provided to a service provider, so that the service provider can advertise the plurality of the VOD assets deployed based on the VOD asset metadata. At block 412, second VOD asset metadata is retrieved from a second VHO. A second plurality of VOD assets deployed to the second VHO is determined based on the second VOD asset metadata at block 414. At block 416, a second list of the second plurality of VOD asset deployed to the second VHO is stored.

At block 418, deployment of the second plurality of VOD assets to the second VHO is verified. Access to the second list of the second plurality of VOD assets deployed to the second VHO is provided at block 420. At block 422, second VOD asset metadata is retrieved from the first VHO. A second plurality of VOD assets deployed to the first VHO is determined based on the second VOD assets metadata at block 424. At block 426, a second list of the second plurality of VOD assets deployed to the first VHO is stored.

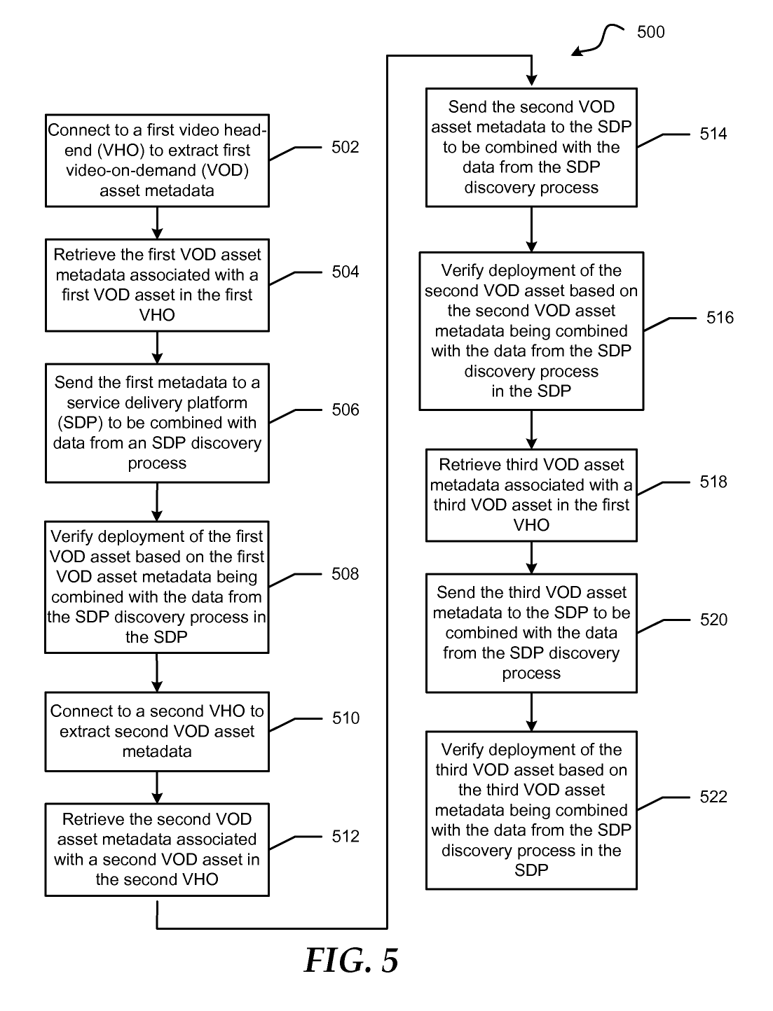

FIG. 5 shows an alternative method 500 for verifying deployment of a VOD asset to a VHO. At block 502, a first VHO is connected to, so that first VOD asset metadata can be extracted. At block 504, first VOD asset metadata associated with a first VOD asset in the first VHO is retrieved. The first VOD asset metadata is sent to an SDP to be combined with data from an SDP discovery process at block 506. At block 508, deployment of the first VOD asset is verified based on the first VOD asset metadata being combined with the data from the SDP discovery process in the SDP.

At block 510, a second VHO is connected to, so that second VOD asset metadata can be extracted. At block 512, second VOD asset metadata associated with a second VOD asset in the second VHO is retrieved. The second VOD asset metadata is sent to the SDP to be combined with the data from the SDP discovery process at block 514. At block 516, deployment of the second VOD asset is verified based on the second VOD asset metadata being combined with the data from the SDP discovery process in the SDP.

At block 512, third VOD asset metadata associated with a third VOD asset in the first VHO is retrieved. The third VOD asset metadata is sent to the SDP to be combined with the data from the SDP discovery process at block 514. At block 516, deployment of the third VOD asset is verified based on the third VOD asset metadata being combined with the data from the SDP discovery process in the SDP.

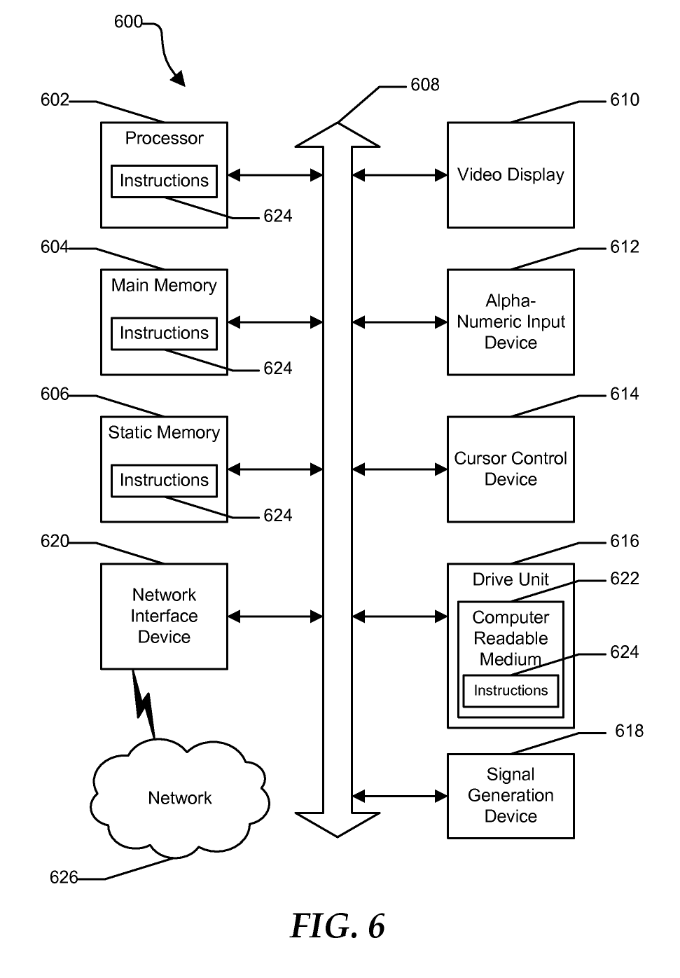

FIG. 6 shows an illustrative embodiment of a general computer system 600 in accordance with at least one embodiment of the present disclosure. The computer system 600 can include a set of instructions that can be executed to cause the computer system to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

The computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media. The network interface device 620 can provide connectivity to a network 626, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method comprising:
retrieving first video-on-demand asset metadata from a first video head-end office;
determining a first plurality of video-on-demand assets deployed to the first video head-end office based on the first video-on-demand asset metadata; and
storing a first list of the first plurality of video-on-demand assets deployed to the first video head-end office.

2. The method of claim 1 further comprising:
verifying deployment of the first plurality of video-on-demand assets to the first video head-end office based on the first video-on-demand asset metadata.

3. The method of claim 1 further comprising:
providing access to the first list of the first plurality of video-on-demand assets deployed.

4. The method of claim 1 further comprising:
retrieving second video-on-demand asset metadata from a second video head-end office;
determining a second plurality of video-on-demand assets deployed to the second video head-end office based on the second video-on-demand asset metadata; and
storing a second list of the second plurality of video-on-demand assets deployed to the second head-end office.

5. The method of claim 4 further comprising:
verifying deployment of the second plurality of video-on-demand assets to the second video head-end office based on the second video-on-demand asset metadata.

6. The method of claim 4 further comprising:
providing access to the second list of the second plurality of video-on-demand assets deployed.

7. The method of claim 1 further comprising:
retrieving second video-on-demand asset metadata from the first video head-end office;
determining a second plurality of video-on-demand assets deployed to the first video head-end office based on the second video-on-demand asset metadata; and
storing a second list of the second plurality of video-on-demand assets deployed.

8. The method of claim 1 wherein the first video-on-demand asset metadata is a title, a summary, a rating, a run time, a year, actors, writers, director, producers, studio, category, genre, licensing start date, licensing end date, suggested price, or any combination thereof.

9. A method comprising:
connecting to a first video head-end office;
retrieving from the first video head-end office first video-on-demand asset metadata associated with a first video-on-demand asset;
sending the first video-on-demand asset metadata to a service delivery platform to be combined with data from a service delivery platform discovery process; and
verifying deployment of the first video-on-demand asset based on the first video-on-demand asset metadata being combined with the data from the service delivery platform discovery process in the service delivery platform.

10. The method of claim 9 further comprising:
connecting to a second video head-end office to extract second video-on-demand asset metadata;
retrieving the second video-on-demand asset metadata associated with a second video-on-demand asset in the second video head-end office;
sending the second video-on-demand asset metadata to the service delivery platform to be combined with the data from the service delivery platform discovery process; and
verifying deployment of the second video-on-demand asset based on the second video-on-demand asset metadata being combined with the data from the service delivery platform discovery process in the service delivery platform.

11. The method of claim 9 wherein the video head-end office is located within a specific geographic location.

12. The method of claim 9 further comprising:
retrieving second video-on-demand asset metadata associated with a second video-on-demand asset in the first video head-end office;
sending the second video-on-demand asset metadata to the service delivery platform to be combined with the data from the service delivery platform discovery process; and
verifying deployment of the second video-on-demand asset based on the second video-on-demand asset metadata being combined with the data from the service delivery platform discovery process in the service delivery platform.

13. The method of claim 9 wherein the first metadata is a title, a summary, a rating, a run time, a year, actors, writers, director, producers, studio, category, genre, licensing start date, licensing end date, suggested price, or any combination thereof.

14. A system comprising:
a subscriber event transmission interface configured to collect first video-on-demand asset metadata from a first video head-end office; and
an enterprise data warehouse in communication with the subscriber event transmission interface, the enterprise data warehouse configured to store a list of video-on-demand assets deployed to the video head-end office based on the first video-on-demand asset metadata.

15. The system of claim 14 further comprising:
a service delivery platform in communication with the subscriber event transmission interface, the service delivery platform configured to combine metadata associated with the video-on-demand assets deployed with data from a service delivery platform discovery process to verify a video-on-demand asset deployment.

16. The system of claim 14 wherein the enterprise data warehouse is further configured to provide the list of the video-on-demand assets deployed to a service provider.

17. The system of claim 14 wherein the video-on-demand assets deployed are based on a regional location of the first video head-end office.

18. The system of claim 14 wherein the subscriber event transmission interface is further configured to collect second video-on-demand asset metadata from a super head-end office.

19. The system of claim 14 wherein the subscriber event transmission interface is further configured to collect second video-on-demand asset metadata from a second video head-end office.

20. The system of claim 14 wherein first video-on-demand asset metadata is a title, a summary, a rating, a run time, a year, actors, writers, a director, producers, a studio, a category, a genre, a licensing start date, a licensing end date, a suggested price, or any combination thereof.
